(19) United States
(12) Patent Application Publication
(10) Pub. No.: US 2016/0269694 A1
(43) Pub. Date: Sep. 15, 2016

(54) IMAGING APPARATUS, IMAGING DEVICE, AND IMAGING METHOD

(71) Applicant: KABUSHIKI KAISHA TOSHIBA, Tokyo (JP)

(72) Inventors: Atsushi Masuda, Yokohama Kanagawa (JP); Nobu Matsumoto, Ebina Kanagawa (JP); Ken Tanabe, Ota Tokyo (JP); Ryuji Hada, Yokohama Kanagawa (JP)

(21) Appl. No.: 14/845,184

(22) Filed: Sep. 3, 2015

(30) Foreign Application Priority Data
Mar. 11, 2015 (JP) 2015-048040

(51) Int. Cl. H04N 9/097; H04N 9/04

(52) U.S. Cl. CPC H04N 9/097; H04N 9/045

(57) ABSTRACT

An imaging apparatus of an embodiment includes a plurality of light receiving units arranged in an array to each detect light with a specific color and a specific polarization angle. In the plurality of light receiving units, both the color and polarization angle to be detected differ between the light receiving units adjacent to each other.

### CROSS-REFERENCE TO RELATED APPLICATION

The present application claims the benefit of priority based on Japanese Patent Application No. 2015-048040 filed on Mar. 11, 2015. The entire contents of the disclosure of the original patent application are incorporated herein by reference.

### FIELD

Embodiments described herein relate to an imaging apparatus, an imaging device, and an imaging method.

### BACKGROUND

An imaging apparatus that can acquire polarization information in addition to color information of an object (hereinafter, referred to as a polarization imaging camera) is known. The polarization imaging camera generally includes a plurality of polarization filters having different polarization angles above a light receiving plane configured with a plurality of light receiving devices, and generates a polarization image for each of the polarization angles based on a pixel group captured with the light receiving devices.

In the polarization imaging camera including a plurality of polarization filters with different polarization angles, the pixels that have captured light having the same polarization angle do not always exist uniformly on the light receiving plane. A portion where an interval between the pixels is long is likely to lack information among the pixels. In this case, the polarization image generated by the polarization imaging camera may be the coarse image with a large amount of information loss.

### DESCRIPTION OF THE DRAWINGS

FIG. 1 is a block diagram of an imaging apparatus of an embodiment;

FIG. 2 is an exemplary specific configuration of the imaging apparatus of the embodiment;

FIG. 3 is a plan view of an imaging device;

FIG. 4 is a cross-sectional view taken along line X-X illustrated in FIG. 3;

FIG. 5 is a view of a filter array seen from the direction of an image forming optical system;

FIG. 6 is an enlarged view of an array pattern;

FIG. 7 is a diagram illustrating how a polarization RAW image is demosaiced;

FIG. 8 is a diagram illustrating an array pattern with long intervals between pixels of the same type;

FIG. 9 is a diagram illustrating a modification of the array pattern;

FIG. 10 is a diagram illustrating a modification of the array pattern;

FIG. 11 is a diagram illustrating a modification of the array pattern;

FIG. 12 is a diagram illustrating a modification of the array pattern;

FIG. 13 is a diagram illustrating a modification of the array pattern;

FIG. 14 is a diagram illustrating a modification of the array pattern;

FIG. 15 is a diagram illustrating a modification of the array pattern; and

FIG. 16 is a diagram illustrating a modification of the array pattern.

### DETAILED DESCRIPTION

An imaging apparatus of an embodiment includes a plurality of light receiving units arranged in an array to each detect light of a specific color and a specific polarization angle. In the plurality of light receiving units, both the color and polarization angle to be detected differ between the light receiving units adjacent to each other.

Hereinafter, an embodiment will be described with reference to the drawings. In the drawings, the same or similar reference signs are given to the same or similar portions.

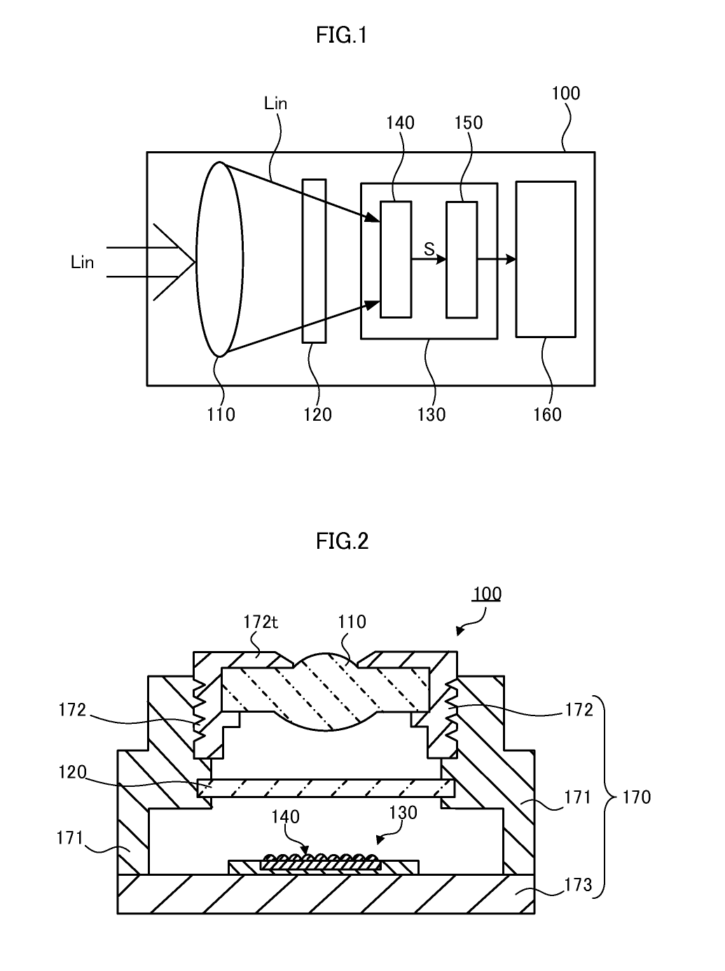

FIG. 1 is a block diagram of an imaging apparatus 100 of the present embodiment. The imaging apparatus 100 is a polarization imaging camera that can acquire polarization information in addition to color information of an object. The imaging apparatus 100 is a small camera module mounted on an electronic apparatus, such as a digital camera, a video camera, and a mobile phone. The imaging apparatus 100 includes an image forming optical system 110, a filter 120, a solid-state imaging apparatus 130, and an image processing unit 160.

The image forming optical system 110 is disposed in a front stage of the solid-state imaging apparatus 130. The image forming optical system 110 collects incident light Lin to form an image on the solid-state imaging apparatus 130. The image forming optical system 110 is a lens, for example.

The filter 120 is disposed between the image forming optical system 110 and the solid-state imaging apparatus 130. The filter 120 blocks light other than visible light included in the incident light Lin (infrared, for example). The filter 120 transmits light of a wavelength ranging from 360 nm to 830 nm, for example, and blocks the light having the other wavelengths. The filter 120 is a visible light transmitting filter, for example.

The solid-state imaging apparatus 130 includes an imaging device 140 and a signal processing unit 150. The solid-state imaging apparatus 130 may be configured with a single solid-state imaging chip, or with a plurality of chips mounted on a substrate. The solid-state imaging apparatus 130 is a CMOS solid-state imaging apparatus, for example.

The imaging device 140 of the present embodiment is a polarization image sensor including a plurality of polarization filters. The imaging device 140 photoelectrically converts the incident light Lin transmitted through the polarization filter and generates an image signal S. The imaging device 140 is a CMOS sensor of a back side illumination (BSI) type, for example.

The signal processing unit 150 processes the image signal S and generates a polarization RAW image. The polarization RAW image is the image that includes pixels of different polarization angles. The signal processing unit 150 may be a logic circuit provided inside the solid-state imaging chip that contains the imaging device 140, or a signal processing chip provided separately from the solid-state imaging chip.

The image processing unit 160 demosaics the polarization RAW image and generates a plurality of polarization images with different polarization angles. Demosaicing is a process to generate the polarization image for each pixel group with the same polarization angle based on the pixel group captured by the imaging device 140. The image processing unit 160 is a processor, for example. The image processing unit 160 outputs the generated polarization image to an interface (not shown). The image processing unit 160 outputs the polarization image to a user interface such as a liquid crystal display.

FIG. 2 is an exemplary specific configuration of the imaging apparatus 100. The imaging apparatus 100 includes a holding mechanism 170 in addition to the configuration illustrated in FIG. 1. The holding mechanism 170 includes a lens holder 171, a lens barrel 172, and a substrate 173.

The lens holder 171 is a tubular body to fix the lens barrel 172, the substrate 173, and the filter 120. The lens holder 171 is formed of light-shielding resin. The filter 120 is fixed in parallel with an opening plane of the lens holder 171, substantially at a center of an inner portion of the lens holder 171. At an inner peripheral surface near an opening on one side (opening on the upper side of the drawing) of the lens holder 171, screw threads are provided to fix the lens barrel 172.

The lens barrel 172 is a tubular body to hold the image forming optical system 110. The lens barrel 172 is formed of light-shielding resin. The lens barrel 172 has a top portion 172t at an opening on one side. The top portion 172t has a circular opening for taking in the incident light Lin to an inner portion of the lens holder 171. The image forming optical system 110 is fixed to the lens barrel 172 such that a spherical surface thereof protrudes from the opening of the top portion 172t. Thread grooves to fit with the threads of the lens holder 171 are provided on the outer peripheral surface of the lens barrel 172. The position of the image forming optical system 110 with respect to the imaging device 140 is adjusted with a vertical movement of the lens barrel 172.

The substrate 173 is provided at an opening on one side of the lens holder 171. More specifically, the substrate 173 is fixed with an adhesive or the like at the opening on the opposite side of the opening where the lens barrel 172 is disposed. The substrate 173 is a printed circuit board, for example. The solid-state imaging apparatus 130 is mounted on a surface of the substrate 173 on the inner side of the lens holder 171. The solid-state imaging apparatus 130 is electrically connected to the image processing unit 160 via wiring on the substrate 173.

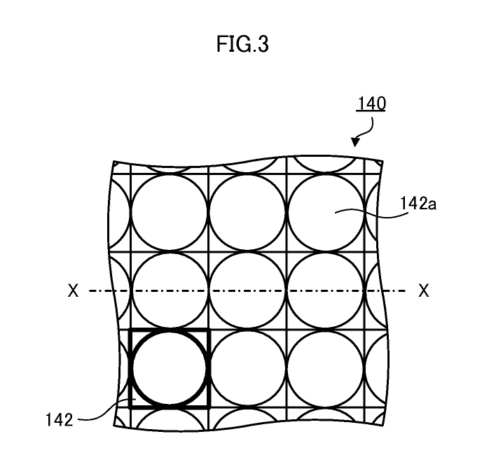

The solid-state imaging apparatus 130 has the imaging device 140 on a surface on the side of the image forming optical system 110. FIG. 3 is a view of the imaging device 140 seen from the direction of the image forming optical system 110. The imaging device 140 includes a plurality of light receiving units 142 disposed in an array. In the figure, a square that contains a circular microlens 142a inside is one light receiving unit 142.

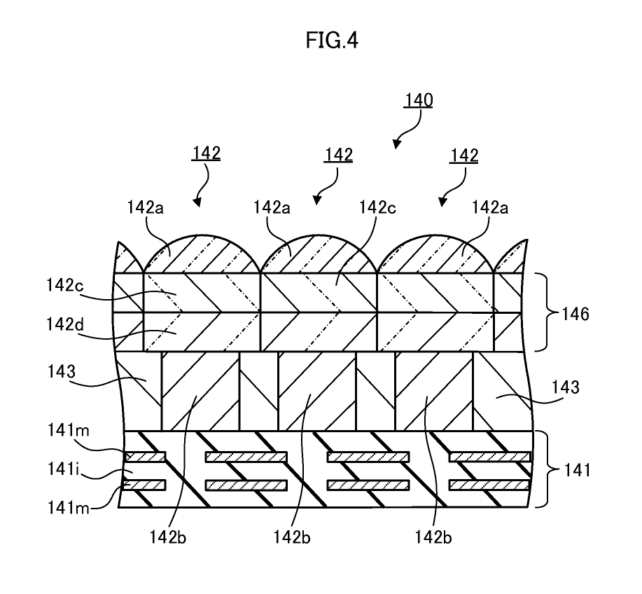

FIG. 4 is a cross-sectional view taken along line X-X illustrated in FIG. 3. The imaging device 140 includes a wiring layer 141 and the plurality of light receiving units 142.

The wiring layer 141 is formed by laminating an interlayer dielectric 141i and wiring 141m. The interlayer dielectric 141i is an insulator such as a silicon oxide film. The wiring 141m is a conductor such as copper (Cu) or aluminum (Al). The wiring 141m is electrically connected to the signal processing unit 150 via wiring on the substrate 173. A signal generated in the light receiving unit 142 is transmitted to the signal processing unit 150 via the wiring 141m.

The light receiving unit 142 photoelectrically converts light with a specific color and polarization angle and generates the image signal S. One light receiving unit 142 corresponds to one pixel. The light receiving unit 142 includes the microlens 142a, a light receiving device 142b, a color filter 142c, and a polarization filter 142d.

The microlens 142a is a micro-size lens with a diameter equal to or less than 1 mm, for example. The plurality of microlenses 142a forms one microlens array.

The light receiving device 142b is disposed on a silicon substrate 143 for each microlens 142a. The light receiving device 142b converts the incident light from the microlens 142a into an electrical signal and outputs the signal to the wiring 141m. The light receiving device 142b is a photodiode, for example.

The color filter 142c transmits light of a specific wavelength. The color filter 142c has a size of one pixel (one light receiving device 142b). The color filter 142c is provided on a light receiving plane of the light receiving device 142b. The color filter 142c is a filter of any color of red, green, and blue, for example. The color filter 142c has a Bayer pattern.

The polarization filter 142d is a polarizer that transmits light of a specific polarization angle. The polarization filter 142d has a size of one pixel (one light receiving device 142b). The plurality of polarization filters 142d disposed in an array includes polarization filters having different polarization angles. For example, the polarization filters have polarization angles which are made different from each other by 45°. The polarization filter 142d is provided on a light receiving plane of the light receiving device 142b.

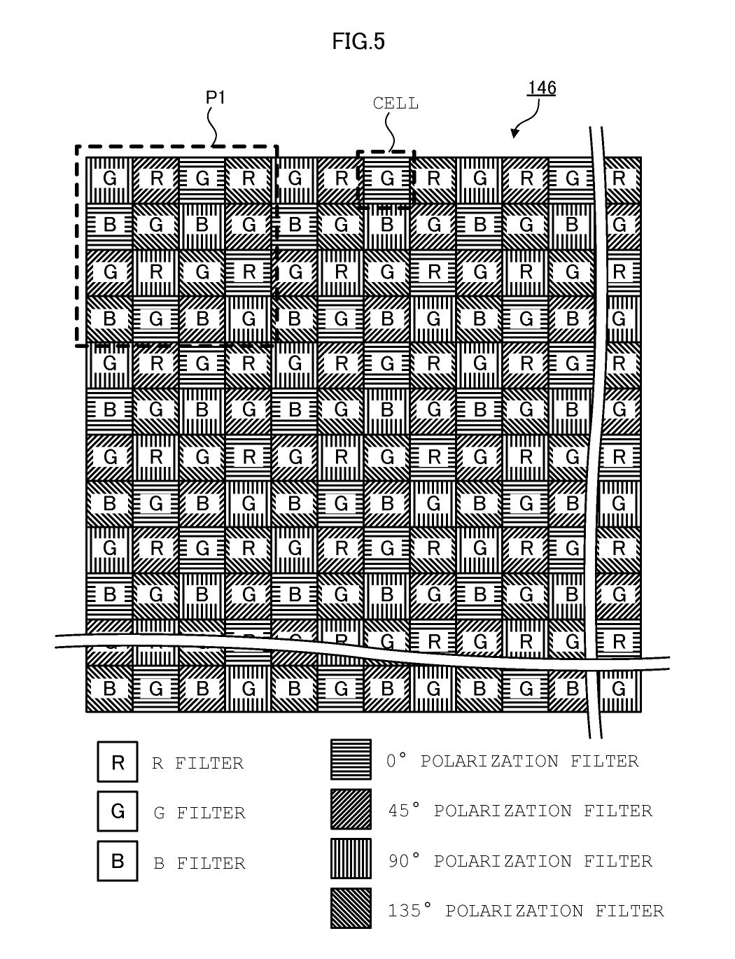

The polarization filter 142d and the color filter 142c are disposed at vertically corresponding positions. In the following description, a combination of the color filter 142c and the polarization filter 142d, disposed in an array, is simply referred to as a filter array 146. FIG. 5 is a plan view of the filter array 146 seen from the direction of the image forming optical system 110. In the figure, one square (hereinafter, referred to as a “cell”) is a combination of one color filter 142c and one polarization filter 142d.

A symbol R, G, or B, given to each cell represents the color of the color filter 142c. R, G, and B represent a red filter (hereinafter, referred to as an R filter), a green filter (hereinafter, referred to as a G filter), and a blue filter (hereinafter, referred to as a B filter), respectively. The R filter mainly transmits light having a wavelength ranging from 620 nm to 750 nm, for example. The G filter mainly transmits light having a wavelength ranging from 495 nm to 570 nm, for example. The B filter mainly transmits light having a wavelength ranging from 455 nm to 495 nm, for example. The above wavelengths are only exemplary and may be varied.

The angles of stripes illustrated in individual cells represent the polarization angles of the polarization filter 142d. Horizontal stripes, right-upward diagonal stripes, vertical stripes, and left-upward diagonal stripes represent a 0° polarization filter, a 45° polarization filter, a 90° polarization filter, and a 135° polarization filter, respectively. The 0° polarization filter described above is assumed here to transmit light having a polarization angle as a reference (hereinafter, referred to as a reference polarization angle). The reference polarization angle is not limited to the above-described angles. The 45° polarization filter transmits light that is tilted 45° counter-clockwise from the reference polarization angle. The 90° polarization filter transmits light that is tilted 90° from the reference polarization angle. The 135° polarization filter transmits light that is tilted 135° counter-clockwise (that is, 45° clockwise) from the reference polarization angle.

The cells are arranged to repeat an array pattern P1. In the present embodiment, the array pattern P1 is a matrix of 4×4. Since the color filter 142c has three types, R, G, and B, and the polarization filter 142d has four types, 0°, 45°, 90°, and 135°, the cells that form the array pattern P1 include 12 combination patterns. In the array pattern P1, both the color and polarization angle are different between adjacent cells (adjacent light receiving units). The above-described adjacent cells are the cells adjoining vertically or horizontally, not including cells diagonally disposed.

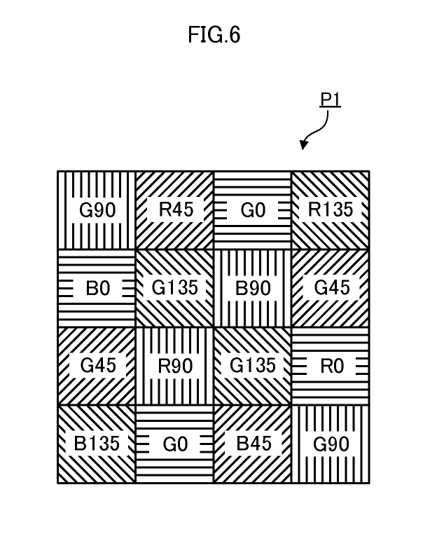

FIG. 6 is an enlarged view of the array pattern P1. In the following description, a combination of the R filter and the 0° polarization filter is referred to as RO. In a similar manner, a combination of the G filter and the 45° polarization filter is referred to as G45, and a combination of the B filter and the 45° polarization filter as B45, and so on.

In the array pattern P1, each column and row is configured with four cells having different combination patterns from each other. For example, a first row of the array pattern P1 includes the four different cells, G90, R45, G0, and R135. Furthermore, a first column of the array pattern P1 includes the four different cells, G90, B0, G45, and B135. In a similar manner, each of second to fourth rows and each of second to fourth columns in the array pattern P1 includes four different cells. Arranging the array pattern P1 as above makes it possible to cause all adjoining cells to have different colors and polarization angles from each other, even when the array pattern P1 is disposed repeatedly on the light receiving plane.

Operations of the imaging apparatus 100 will be described in the following.

First, the image forming optical system 110 collects the incident light Lin to form an image on a surface of the imaging device 140. At this time, the filter 120 blocks the light other than visible light included in the incident light Lin.

The microlens 142a of the imaging device 140 collects the incident light Lin to the light receiving device 142b. At this time, the color filter 142c transmits light with a specific color. The polarization filter 142d transmits light having a specific polarization angle. The light receiving device 142b generates the image signal S based on the light that has been transmitted through the color filter 142c and the polarization filter 142d and has reached the light receiving plane, and outputs the image signal S to the signal processing unit 150.

The signal processing unit 150 processes the image signal S and generates the polarization RAW image. The polarization RAW image is the image that contains information on pixels of the different polarization angles (RO, R45, etc.). The signal processing unit 150 transmits the polarization RAW image to the image processing unit 160.

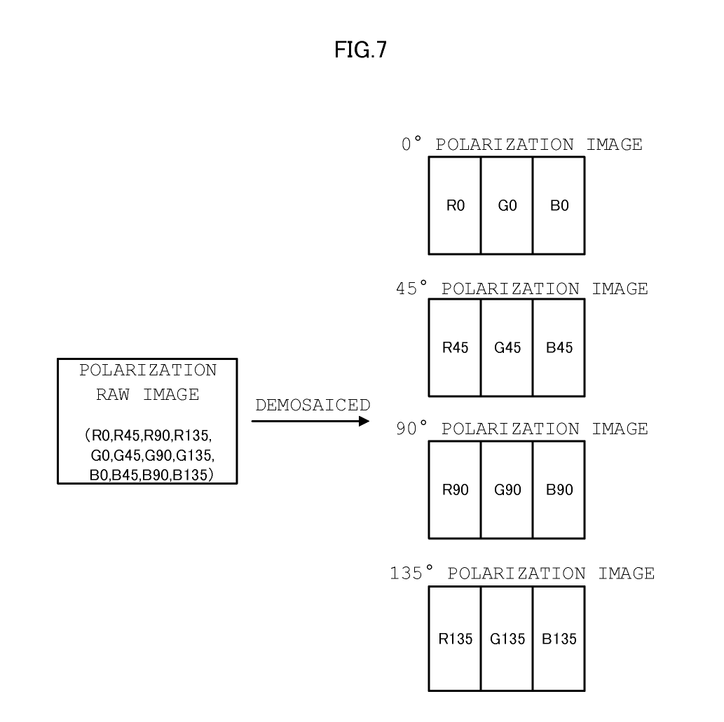

The image processing unit 160 demosaics the polarization RAW image and generates a plurality of polarization images with different polarization angles. FIG. 7 illustrates how the polarization RAW image is demosaiced. For example, the image processing unit 160 generates the polarization images having polarization angles of 0°, 45°, 90°, and 135°. At this time, the image processing unit 160 may interpolate missing information on a pixel from the information on surrounding pixels. The image processing unit 160 outputs the polarization image to an interface (not shown).

When the same type of color filter or polarization filter is disposed as an adjacent pixel, the polarization image to be generated may be a low resolution image. This is related to the fact that the array pattern is repeatedly disposed in the filter. Having the same type of pixel adjacent to a pixel means that the same type of pixel on the other side is disposed at a long distance. That is, an interval between the same type of pixels is long. For example, when a thin line shaped image comes at the position where no cells with a certain polarization angle are disposed in the same column or row, the image information for the same cell is not used for generating the polarization image. As a result, resolution of the polarization image is lowered. An extreme example of this is an array pattern P2 illustrated in FIG. 8. FIG. 8 illustrates an array pattern where pixels of the same type have a long interval therebetween. In the array pattern P2, randomly-selected pixels adjacent to each other have the same type of color filters or the same type of polarization filters. In this case, on one side, at least one pixel with the same type of color filter or the same type of polarization filter exists adjacent to the pixel; on the other side, however, there is an interval of two pixels between the pixel and the next pixel of the same type. This may cause missing information in an image formed across the two pixels.

The imaging apparatus 100 of the present embodiment, however, has the filter array 146 in which the array pattern P1 is repeated. The array pattern P1 includes all combination patterns of the colors and polarization angles that are detectable in the light receiving unit 142, with the pixels adjacent to each other having different colors and polarization angles. Therefore, the pixels with the same polarization angles are disposed uniformly on the surface of the imaging device 140, enabling the imaging apparatus 100 to generate a polarization image with high accuracy and less missing information.

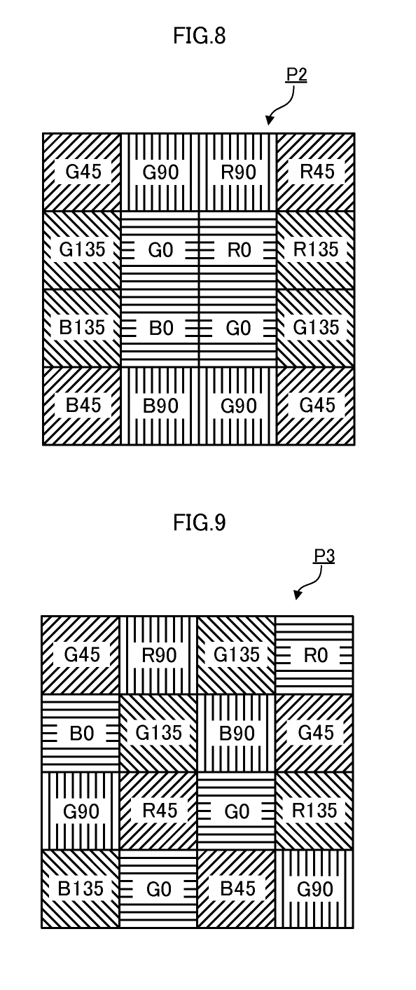

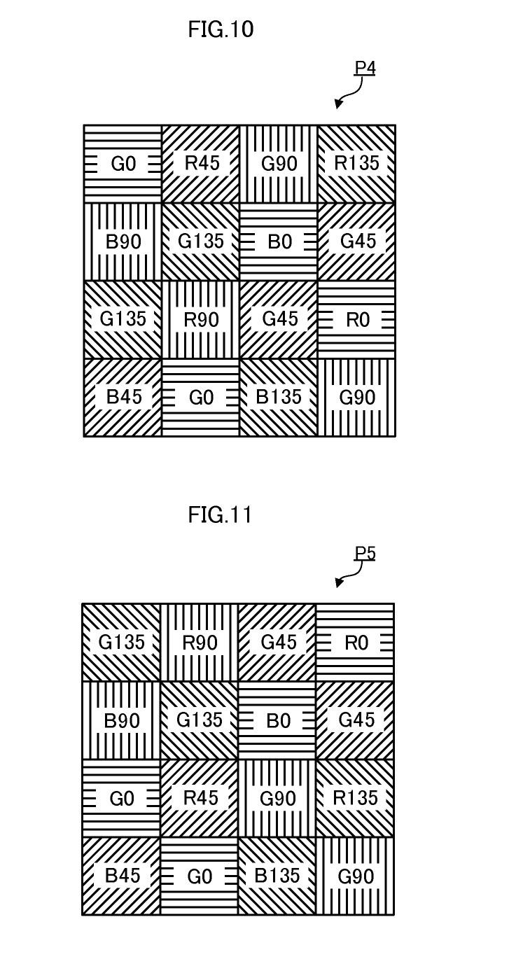

Note that the present embodiment is an example, and various modifications and applications are possible. For example, the filter array 146 may be a repetition of any of array patterns P3 to P5 illustrated in FIGS. 9 to 11, respectively. The array patterns P3 to P5 also include all combination patterns of the colors and polarization angles that are detectable in the light receiving unit 142, with the pixels adjacent to each other having different colors and different polarization angles. Therefore, the imaging apparatus 100 can generate a polarization image with high accuracy and less missing information

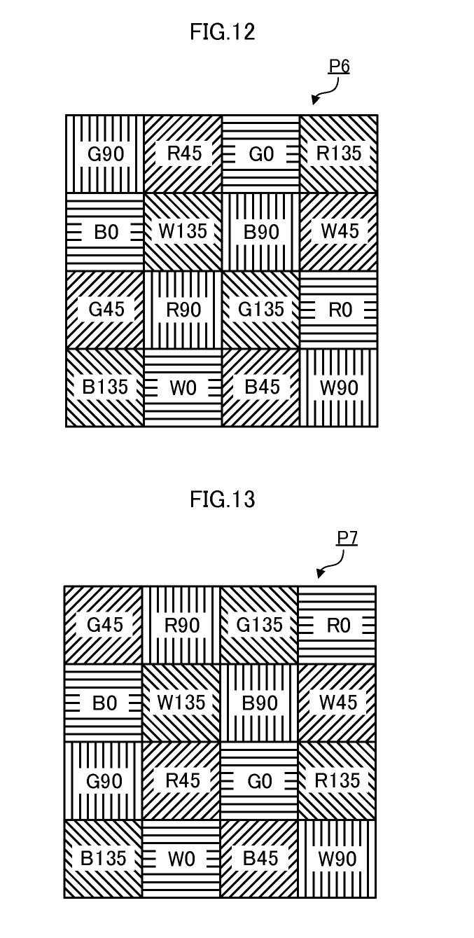

The color of the color filter 142c is not limited to three colors. The color filter 142c may be of four colors including a white color. For example, it is possible to change the arrangement of the color filter 142c such that one of the two greens (G) in a 4×4 matrix is replaced with white (W). FIG. 12 is a diagram illustrating a modification of the array pattern. An array pattern P6 includes 16 combination patterns formed with four colors (R, G, B, and W) and four polarization angles (0°, 45°, 90°, and 135°).

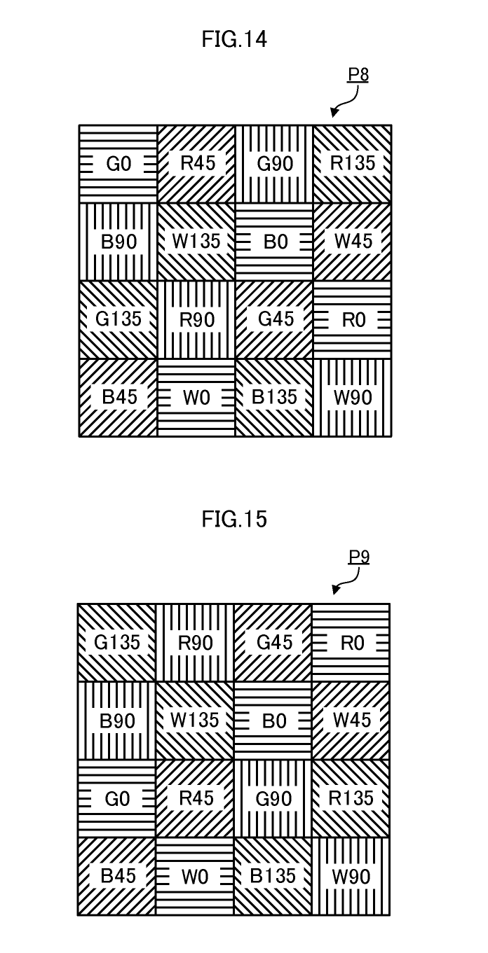

A color and polarization angle arrangement of the filter array 146 can be modified as appropriate, as long as the pattern includes all the 16 combination patterns and the pixels adjacent to each other have different colors and different polarization angles. For example, the filter array 146 may be a repetition of any of array patterns P7 to P9 illustrated in FIGS. 13 to 15, respectively.

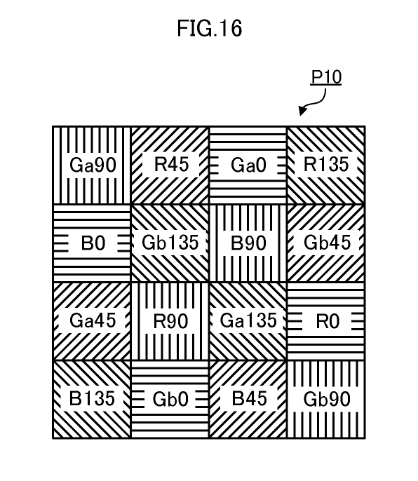

Furthermore, the color filter 142c may be of four colors, R, Ga, Gb, and B, where two types of green color with different transmission wavelengths are included. For example, an array of the color filter 142c may be modified such that two greens in a 4×4 matrix are replaced with two types of greens (Ga, Gb) with different wavelengths. FIG. 16 is a diagram illustrating a modification of the array pattern. An array pattern P10 includes 16 combination patterns of four colors (R, Ga, Gb, and B) and four polarization angles (0°, 45°, 90°, and 135°). In a similar manner, the filter array 146 may be a repetition of an array pattern in which G is replaced with Ga and W is replaced with Gb in the array patterns P7 to P9 illustrated in FIGS. 13 to 15.

The type of polarization filter 142d is not limited to four. The type of the polarization filter 142d may be less than four types, or may be more than four types. In a similar manner, the type of the color filter 142c may be less than three types, and may be more than four types.

The polarization filter 142d may be disposed next to the microlens 142a, with the color filter 142c disposed next to the light receiving device 142b. A planarizing layer may be provided between the color filter 142c and the polarization filter 142d. The planarizing layer may be a transparent silicon oxide film, for example, to accommodate irregularities between the filters. The planarizing layer may be provided between the light receiving device 142b and the polarization filter 142d (or the color filter 142c).

The imaging device 140 may be a CMOS image sensor of the front side illumination (FSI) type. The imaging device 140 may be a CCD image sensor or a CMD image sensor.

The imaging apparatus 100 may be configured without the filter 120. The imaging apparatus 100 maybe a digital camera, a video camera, a mobile phone, or any other finished product.

The embodiments according to the present invention have been described above, but the embodiments are demonstrated by way of example and do not intend to limit the scope of the invention. The novel embodiments may be accomplished in various forms and may be variously omitted, replaced and changed without departing from the scope of the invention. The embodiments and their variants are encompassed in the scope or spirit of the invention, and are encompassed in the invention described in Claims and the range of its equivalents.

What is claimed is:

1. An imaging apparatus comprising a plurality of light receiving units arranged in an array to each detect light with a specific color and a specific polarization angle,
wherein the light receiving unit is configured such that both the color and polarization angle to be detected differ between the light receiving units adjacent to each other.

2. The imaging apparatus according to claim 1, wherein the light receiving unit includes all combination patterns of detectable colors and polarization angles.

3. The imaging apparatus according to claim 2, wherein the plurality of light receiving units comprises:
a first light receiving unit configured to detect light of a first polarization angle;
a second light receiving unit configured to detect light of a second polarization angle;
a third light receiving unit configured to detect light of a third polarization angle; and
a fourth light receiving unit configured to detect light of a fourth polarization angle.

4. The imaging apparatus according to claim 2, wherein the plurality of light receiving units comprises:
a first light receiving unit configured to detect light of a first color;
a second light receiving unit configured to detect light of a second color; and
a third light receiving unit configured to detect light of a third color.

5. The imaging apparatus according to claim 1, wherein the plurality of light receiving units includes 12 combination patterns obtained by combining three colors and four polarization angles.

6. The imaging apparatus according to claim 5, wherein the arrangement of the plurality of light receiving units is a repetition of a matrix of 4×4 configured with the 12 combination patterns, and
the matrix is configured such that each column and row is formed with four light receiving units having different combination patterns from each other.

7. The imaging apparatus according to claim 2, wherein the plurality of light receiving units comprises:
a first light receiving unit configured to detect light of a first color;
a second light receiving unit configured to detect light of a second color;
a third light receiving unit configured to detect light of a third color; and
a fourth light receiving unit configured to detect light of a fourth color.

8. The imaging apparatus according to claim 1, wherein the plurality of light receiving units includes 16 combination patterns obtained by combining four colors and four polarization angles.

9. The imaging apparatus according to claim 8, wherein the arrangement of the plurality of light receiving units is a repetition of a matrix of 4×4 configured with the 16 combination patterns, and
the matrix is configured such that each column and row is formed with four light receiving units having different combination patterns from each other.

10. The imaging apparatus according to claim 1, wherein the light receiving unit comprises a light receiving device, a color filter, and a polarization filter.

11. The imaging apparatus according to claim 10, wherein the polarization filters of the plurality of light receiving units include four kinds of polarization filters in which polarization angles are different from each other by 45°.

12. The imaging apparatus according to claim 11, wherein the color filters of the plurality of light receiving units include color filters of red, blue, and green.

13. The imaging apparatus according to claim 10, wherein the plurality of light receiving units includes 12 combination patterns obtained by combining four types of polarization filters and three types of color filters,
the arrangement of the plurality of light receiving units is a repetition of a matrix of 4×4 including all the 12 combination patterns, and
the matrix is configured such that each column and row is formed with four light receiving units having different combination patterns from each other.

14. The imaging apparatus according to claim 12, wherein the plurality of color filters has a Bayer pattern.

15. The imaging apparatus according to claim 11, wherein a plurality of color filters included in the plurality of light receiving units includes color filters of red, blue, green, and white.

16. The imaging apparatus according to claim 11, wherein a plurality of color filters included in the plurality of light receiving units includes color filters of red, blue, and two kinds of greens with different wavelengths.

17. The imaging apparatus according to claim 10, wherein the plurality of light receiving units includes 16 combination patterns obtained by combining four types of polarization filters and four types of color filters,
the arrangement of the plurality of light receiving units is a repetition of a matrix of 4×4 including all the 16 combination patterns, and
the matrix is configured such that each column and row is formed with four light receiving units having different combination patterns from each other.

18. The imaging apparatus according to claim 1, comprising:
an imaging device including the plurality of light receiving units; and
a processor configured to classify pixel groups imaged with the imaging device into individual pixel groups with the same polarization angles, and thereby to generate a plurality of polarization images with different polarization angles.

19. An imaging device comprising a plurality of light receiving units arranged in a matrix to each detect light with a specific color and a specific polarization angle,
wherein the light receiving unit is configured such that both the color and polarization angle to be detected differ between the light receiving units adjacent to each other.

20. An imaging method comprising:
capturing an image with an imaging device including a plurality of light receiving units arranged in an array to each detect light with a specific color and a specific polarization angle, the plurality of light receiving units being configured such that both the color and polarization angle to be detected differ between the light receiving units adjacent to each other; and
generating a plurality of polarization images with the same polarization angles based on a pixel group captured by the imaging device.
